(19) United States
(12) Patent Application Publication
(10) Pub. No.: US 2017/0278452 A1
(43) Pub. Date: Sep. 28, 2017

(54) DISPLAY APPARATUS AND METHOD OF MANUFACTURING THE SAME

(71) Applicant: SAMSUNG DISPLAY CO., LTD., YONGIN-SI, (KR)

(72) Inventors: CHANGGIL OH, CHEONAN-SI (KR); SEONMI KIM, SUWON-SI (KR); CHANG SIN KIM, SUWON-SI (KR)

(21) Appl. No.: 15/408,558

(22) Filed: Jan. 18, 2017

(30) Foreign Application Priority Data
Mar. 24, 2016 (KR) 10-2016-0035477

(51) Int. Cl. G09G 3/20

(52) U.S. Cl. CPC G09G 3/2092; G09G 2310/08; G09G 2300/04; G09G 2300/0408

(57) ABSTRACT

A display apparatus includes a display panel. The display panel includes a substrate including a display area and a peripheral area adjacent to the display area, and a pixel array disposed on the display area. The display apparatus further includes a driving chip mounted on the peripheral area and configured to provide a driving signal to the pixel array. The driving chip includes a plurality of pads that are electrically connected to the display panel and disposed along a first direction. The pads include an input pad and a conductive alignment pad having a shape different from a shape of the input pad.

### CROSS-REFERENCE TO RELATED APPLICATION

This application claims priority under 35 USC §119 to Korean Patent Application No. 10-2016-0035477, filed on Mar. 24, 2016 in the Korean Intellectual Property Office, the disclosure of which is incorporated by reference herein in its entirety.

### TECHNICAL FIELD

Exemplary embodiments of the present inventive concept relate generally to a display apparatus, and more particularly, to a display apparatus and a method of manufacturing the display apparatus.

### DISCUSSION OF THE RELATED ART

Generally, the display panel of a display apparatus may include an active area to display an image, a peripheral area adjacent to the active area and a display panel driving part that applies a driving signal to the display panel. Furthermore, the display apparatus may include a controller that outputs a control signal to the driving circuit of the display panel.

For example, in a Chip-On-Glass (COG) type of display apparatus, which may include a driving chip disposed on the peripheral area, an alignment mark is disposed on the driving chip so that the driving chip may be mounted on the peripheral area.

Because the alignment mark is disposed on the driving chip, the size of the driving circuit may have to be increased. Larger driving circuits reference a larger peripheral area and a larger bezel.

### SUMMARY

According to an exemplary embodiment of the present inventive concept, a display apparatus includes a display panel. The display panel includes a substrate including a display area and a peripheral area adjacent to the display area, and a pixel array disposed on the display area. The display apparatus further includes a driving chip mounted on the peripheral area and configured to provide a driving signal to the pixel array. The driving chip includes a plurality of pads that are electrically connected to the display panel and disposed along a first direction. The pads include an input pad and a conductive alignment pad having a shape different from a shape of the input pad.

In an exemplary embodiment of the present inventive concept, the conductive alignment pad includes a protrusion.

In an exemplary embodiment of the present inventive concept, the conductive alignment pad has a triangular shape.

In an exemplary embodiment of the present inventive concept, the conductive alignment pad has a circular shape or an oval shape.

In an exemplary embodiment of the present inventive concept, the driving chip further includes a plurality of output pads electrically connected to the pixel array and disposed along the first direction.

In an exemplary embodiment of the present inventive concept, the display panel further includes a panel alignment pad disposed on the peripheral area and aligned with and electrically connected to the conductive alignment pad.

In an exemplary embodiment, the panel alignment pad has a shape substantially similar to the shape of the conductive alignment pad.

In an exemplary embodiment of the present inventive concept, the conductive alignment pad is disposed on a surface of the driving chip, and the panel alignment pad is disposed on a surface of the peripheral area facing the surface of the driving chip.

In an exemplary embodiment of the present inventive concept, the conductive alignment pad is disposed adjacent an edge of the surface of the driving chip.

In an exemplary embodiment of the present inventive concept, the display panel further includes a data line electrically connected to the pixel array, and the driving chip is configured to provide the driving signal to the data line.

In an exemplary embodiment of the present inventive concept, the display panel further includes a gate line electrically connected to the pixel array, and the driving chip is configured to provide the driving signal to the gate line.

In an exemplary embodiment of the present inventive concept, the display panel further includes a display layer disposed on the pixel array, wherein the display layer includes an organic light-emitting layer or a liquid crystal layer.

In an exemplary embodiment of the present inventive concept, the display apparatus further includes a controller electrically connected to the driving chip and configured to generate a control signal and to output the control signal to the driving chip. The driving chip is configured to generate the driving signal based on the control signal.

In an exemplary embodiment of the present inventive concept, the controller is connected to the display panel through a flexible substrate.

According to an exemplary embodiment of the present inventive concept, a method of manufacturing a display apparatus includes disposing a driving chip on a display panel. The driving chip includes a conductive alignment pad and is configured to generate a driving signal. The display panel includes a substrate including a display area and a peripheral area adjacent to the display area, a panel alignment pad disposed on the peripheral area, a pixel array disposed on the display area, and an input pad disposed on the peripheral area and is electrically connected to the pixel array. The method further includes aligning the driving chip on the peripheral area by aligning the conductive alignment pad with the panel alignment pad, and mounting the driving chip on the peripheral area.

In an exemplary embodiment of the present inventive concept, the conductive alignment pad and the panel alignment pad are identical in size and shape.

In an exemplary embodiment of the present inventive concept, the shape of the conductive alignment pad and the panel alignment pad have a triangular, round, or oval shape.

In an exemplary embodiment of the present inventive concept, the method of manufacturing a display apparatus further includes connecting a controller, which is configured to generate a control signal, to the display panel.

In an exemplary embodiment of the present inventive concept, the method of manufacturing a display apparatus further includes connecting a flexible substrate to the peripheral area of the substrate, and connecting the flexible substrate to the controller.

In an exemplary embodiment of the present inventive concept, the flexible substrate is connected to the controller and the display panel through a thermal compression process to connect the controller to the display panel.

According to an exemplary embodiment of the present inventive concept, a display apparatus includes a display panel. The display panel includes a substrate and a pixel array disposed on the substrate. The display apparatus further includes a driving chip mounted on an area adjacent to the pixel array of the substrate and configured to provide a driving signal to the pixel array. The driving chip includes a string of pads arranged along a first direction on a surface of the driving chip facing the substrate. The string of pads includes a plurality of conductive alignment pads, each disposed on the surface adjacent to an end of the driving chip. The string of pads further includes a plurality of input pads disposed between the conductive alignment pads. The conductive alignment pads have a shape different from a shape of the plurality of input pads. The driving chip further includes a plurality of output pads disposed in a zig-zag configuration.

In an exemplary embodiment of the present inventive concept, at least two strings of output pads, each string aligned along the first direction, with output pads aligned alternately along the at least two strings.

In an exemplary embodiment of the present inventive concept, the conductive alignment pads have a structure substantially similar to the input pad combined with a protrusion that protrudes from the input pad.

### BRIEF DESCRIPTION OF THE DRAWINGS

Exemplary embodiments of the present inventive concept will be more clearly understood by describing in detail exemplary embodiments thereof with reference to the accompanying drawings:

FIG. 1 is a plan view illustrating a display apparatus according to an exemplary embodiment of the present inventive concept;

FIG. 2 is a perspective view illustrating the display apparatus of FIG. 1 according to an exemplary embodiment of the present inventive concept;

FIG. 3 is a perspective view illustrating a data driving chip according to an exemplary embodiment of the present inventive concept;

FIG. 4 is a bottom view illustrating the data driving chip of FIG. 3;

FIG. 5 is an enlarged view illustrating the region ‘A’ of a peripheral area of FIG. 1 according to an exemplary embodiment of the present inventive concept;

FIG. 6 is a bottom view illustrating a data driving chip according to an exemplary embodiment of the present inventive concept;

FIG. 7 is a bottom view illustrating a data driving chip according to an exemplary embodiment of the present inventive concept;

FIG. 8 is a plan view illustrating a display apparatus according to an exemplary embodiment of the present inventive concept;

FIG. 9 is a perspective view illustrating the display apparatus of FIG. 8;

FIG. 10 is a perspective view illustrating a gate driving chip of FIG. 8 according to an exemplary embodiment of the present inventive concept; and

FIGS. 11, 12, 13 and 14 are perspective views and an enlarged view for illustrating a method of manufacturing a display apparatus according to an exemplary embodiment of the present inventive concept.

### DETAILED DESCRIPTION OF THE EMBODIMENTS

Hereinafter, the present inventive concept will be described more fully with reference to the accompanying drawings, in which exemplary embodiments of the present inventive concept are shown.

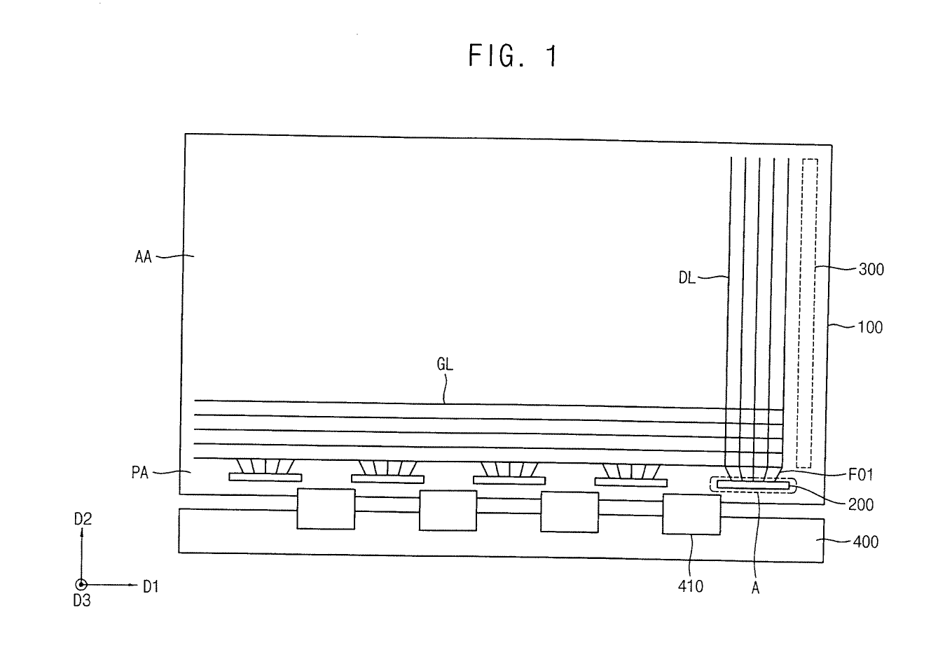

Referring to FIGS. 1, 2, 3, 4, 5, 6 and 7, a display apparatus may include a display panel 100 and a display panel driving part that includes a data driving chip 200.

The display panel 100 includes an active area AA that displays an image, and a peripheral area PA that is adjacent to the active area AA. In an exemplary embodiment of the present inventive concept, the peripheral area PA does not display an image. Hereinafter, the active area AA may be referred as a display area.

The display panel 100 may include a pixel array disposed on the active area AA of the display panel 100. For example, the display panel 100 may include a plurality of gate lines GL extending in a first direction D1 (e.g., an x-axis direction), and a plurality of data lines DL extending in a second direction D2 (e.g., a y-axis direction) crossing the gate lines GL extending in the first direction D1 (e.g., the x-axis direction). The display panel 100 may include, of the pixel array, a plurality of pixels electrically connected to the gate lines GL and the data lines DL, respectively. Further, the gate lines GL, the data lines DL and the pixels are disposed on the active area AA of the display panel 100.

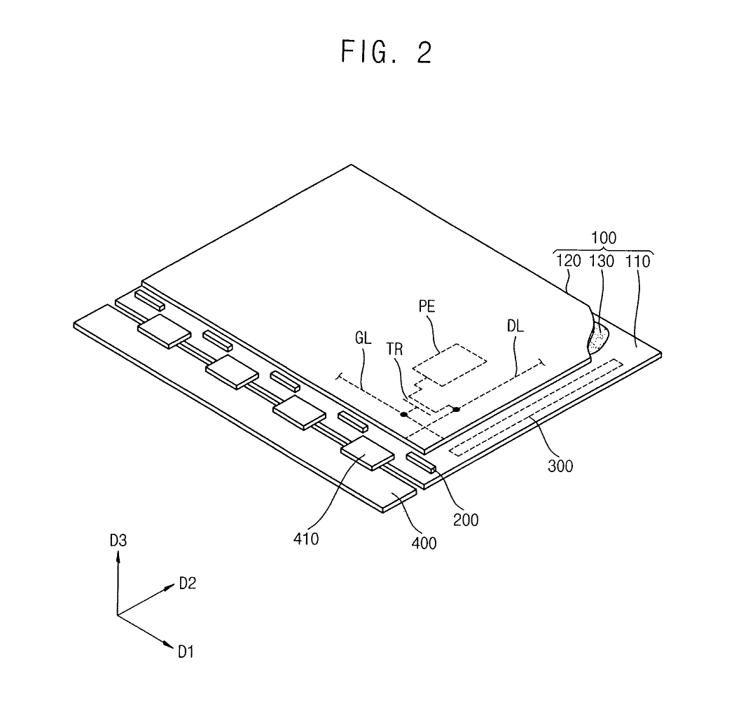

Each of the pixels of the pixel array may include a switching element TR (e.g., as illustrated in FIG. 2) and a pixel electrode PE (e.g., as illustrated in FIG. 2) electrically connected to the switching element TR. The pixels may be arranged in a matrix configuration.

In an exemplary embodiment of the present inventive concept, each of the pixels may further include a storage capacitor electrically connected to the switching element TR. Furthermore, even though one switching element TR is shown in FIGS. 1 and 2, the present disclosure is not limited thereto. For example, at least two switching elements may be disposed for each of the pixels (e.g., electrically connected to the pixels) in an exemplary embodiment of the present inventive concept. For example, a switching transistor and a driving transistor may be disposed for each of pixels (e.g., electrically connected to the pixels).

The display panel 100 may include a first substrate 110 and a second substrate 120 disposed on the first substrate 110 (e.g., as illustrated in FIG. 2). For example, a surface of the second substrate 120 may be facing the first substrate 110. In addition, the first substrate 110 may be, for example, an array substrate.

Further, the gate lines GL and the data lines DL may be disposed on the first substrate 110. Furthermore, the switching elements TR electrically connected to the gate lines GL and the data lines DL may be disposed on the first substrate 110. Furthermore, the pixel electrode PE may be disposed on the first substrate 110.

The second substrate 120 may be an opposing substrate. For example, the second substrate 120 may be facing the first substrate 110. A common electrode may be disposed under the second substrate 120 to face the pixel electrode PE disposed on the first substrate 110. Furthermore, a color filter that defines a color of a pixel may be disposed under the second substrate 120. In an exemplary embodiment of the present inventive concept, the common electrode and the color filter may be disposed on the first substrate 110.

In an exemplary embodiment of the present inventive concept, the second substrate 120 may be an encapsulation layer to encapsulate, for example, organic light-emitting elements and to further encapsulate the pixel electrode PE and switching elements TR. The encapsulation layer may include an inorganic material such as silicon nitride and/or a metal oxide.

Further, an area where the first substrate 110 overlaps the second substrate 120 may be substantially the same as the active area AA of the display panel 100. In addition, the active area AA may be defined as the area where the first substrate 110 overlaps the second substrate 120 and as an area excluding an area where a sealing member is disposed.

The display panel 100 may further include a display layer 130 interposed between the first substrate 110 and the second substrate 120. For example, the display layer 130 may include an organic light-emitting layer or a liquid crystal layer. The display layer 130 may be disposed on the pixel electrode PE to display an image in response to a voltage applied to the pixel electrode PE and the common electrode.

The display panel driving circuit may include a gate driving circuit 300 and a data driving circuit including a data driving chip 200. Further, the display panel driving circuit may provide a driving signal to the display panel 100.

In an exemplary embodiment of the present inventive concept, the display apparatus may further include a controller 400 outputting a control signal to the gate driving circuit 300 and the data driving circuit. The controller 400 may include a printed circuit board (PCB).

Furthermore, the controller 400 may be connected to the peripheral area PA through a flexible substrate 410. The flexible substrate 410 may include a polyimide film.

A timing controller and a power supply part may be disposed on the printed circuit board of the controller 400.

The timing controller may receive an input image data and an input control signal from an external device. The input image data may include a red image data, a green image data and a blue image data. For example, the input control signal may include a master clock signal and a data enable signal. The input control signal may further include a vertical synchronization signal and a horizontal synchronization signal.

The timing controller may generate a first control signal, a second control signal and a data signal based on the input image data and the input control signal.

The timing controller may generate the first control signal for controlling the gate driving circuit 300 based on the received input control signal. In addition, the timing controller may output the first control signal to the gate driving circuit 300.

The timing controller may generate the second control signal for controlling the data driving circuit based on the received input control signal. In addition, the timing controller may output the second control signal to the data driving circuit.

The timing controller may generate a data signal based on the received input image data. The timing controller may output the data signal to the data driving circuit.

The gate driving circuit 300 may generate gate signals in response to the first control signal provided from the timing controller. The gate driving circuit 300 may generate the gate signals for driving the gate lines GL. The gate driving circuit 300 may sequentially output the gate signals to the gate lines GL.

For example, the gate driving circuit 300 may be disposed on the peripheral area PA so that the display panel 100 may have amorphous silicon gate (ASG).

The data driving circuit may receive the second control signal and the data signal from the timing controller. The data driving circuit may convert the data signal into an analog data voltage.

For example, the data driving chip 200 may provide the analog data voltage to the data line DL through a first fan-out line F01 that is disposed on the peripheral area PA and may be electrically connected to the data line DL.

The control signal generated by the timing controller may include the first control signal, the second control signal and the data signal. Furthermore, the driving signal output from the display panel driving circuit may include the gate signal and the data voltage.

The data driving circuit may include a plurality of data driving chips 200, which may be disposed on the peripheral area PA along the first direction D1 (e.g., the x-axis direction) through a chip-on-glass (COG) method.

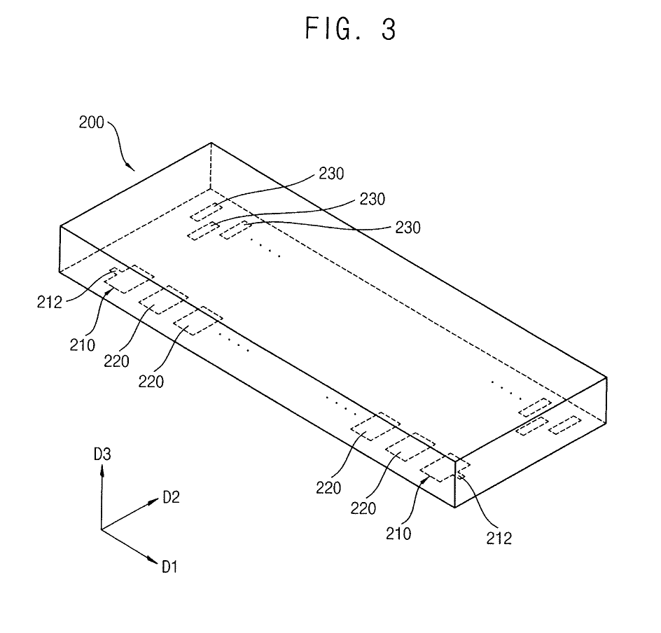

As illustrated in FIG. 3, each of the data driving chips 200 may include a plurality of input pads 220, a plurality of output pads 230 and a plurality of conductive alignment pads 210, which are disposed on a surface thereof.

Each of the conductive alignment pads 210 may include a protrusion 212. For example, each of the conductive alignment pads 210 may have a structure substantially the same as the input pad 220 combined with the protrusion 212 protruding from the input pad 220.

Furthermore, the conductive alignment pads 210 may be disposed on a first end and a second end, which may be opposite to the first end, on the surface of the data driving chip 200. For example, the surface of the data driving chip 200 having the conductive alignment pads 210 disposed thereof may be facing the first substrate 110. The input pads 220 may be disposed along the first direction D1 (e.g., the x-axis direction) between the conductive alignment pads 210.

The conductive alignment pads 210 and the input pads 220 may be electrically connected to the controller 400 through the flexible substrate 410, which connects to the controller 400 and the first substrate 100. The control signal generated by the timing controller may be received by the data driving chip 200 through the conductive alignment pads 210 and the input pads 220.

The output pads 230 may be disposed along the first direction D1 (e.g., the x-axis direction). In addition, the output pads 230 may be disposed on a side opposite to that of the conductive alignment pads 310 and input pads 320. Furthermore, the data driving chip 200 may generate the driving signal generated based on the control signal and may provide the driving signal to the display panel 100 through the output pads 230.

Furthermore, the output pads 230 may be arranged along the first direction D1 (e.g., the x-axis direction) in a zig-zag configuration. For example, a continued pattern where a first output pad 230 and a second output pad 230 may be aligned, while a third output pad 230 is interposed between the first and second output pads 230. Further, the third output pad is offset from the alignment of the first and second output pads 230. The zig-zag configuration facilitates a housing of more output pads within the width of the display panel. Further a pitch (or distance) between neighboring first fan-out lines F01 electrically connected to the output pads 230 may be reduced.

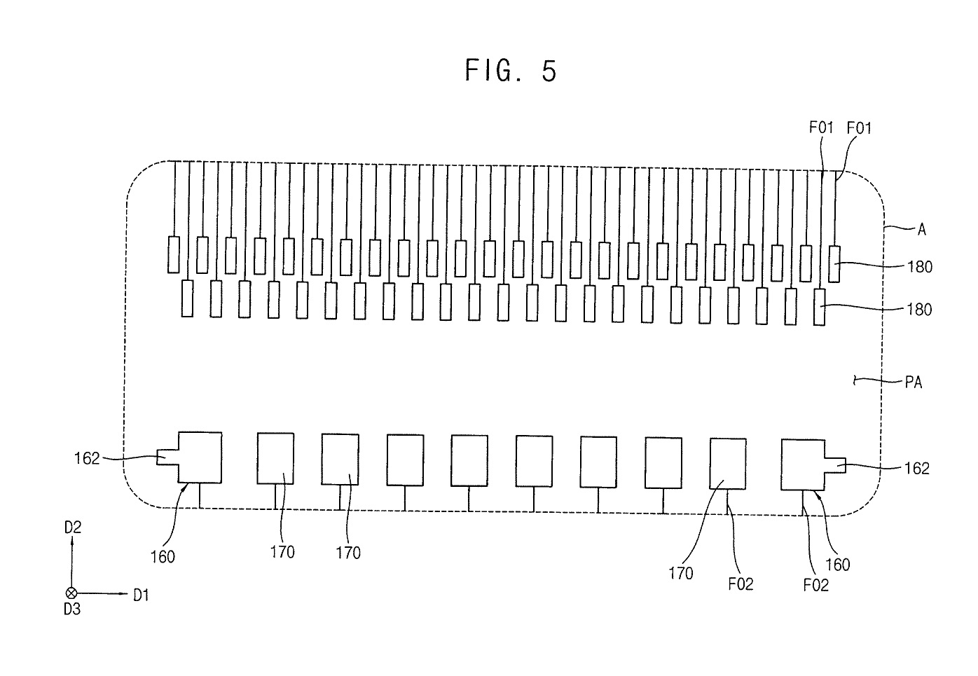

FIG. 5 is an enlarged view illustrating the region ‘A’ of a peripheral area of FIG. 1 according to an exemplary embodiment of the present inventive concept.

As illustrated in FIG. 5, the display panel 100 may further include a plurality of panel input pads 170, a plurality of panel output pads 180 and a plurality of panel alignment pads 160, which are disposed on the peripheral area PA.

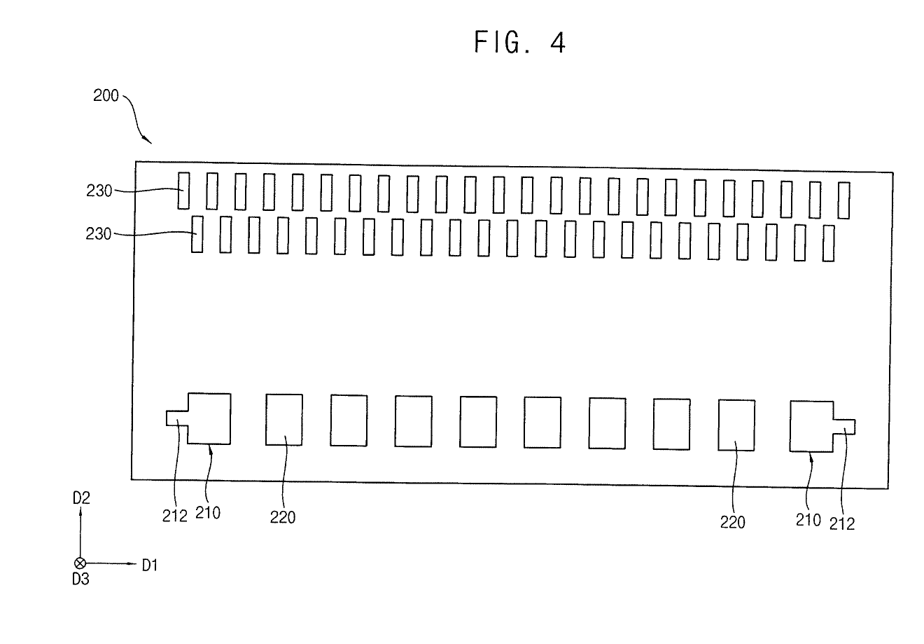

The panel input pads 170 may correspond to and contact the input pads 220 of the data driving chip 200 (e.g., as illustrated in FIG. 4). The panel output pads 180 may correspond to and contact the output pads 230 of the data driving chip 200 (e.g., as illustrated in FIG. 4). The panel alignment pads 160 may correspond to and contact the conductive alignment pads 210 of the data driving chip 200 (e.g., as illustrated in FIG. 4). For example, when the data driving chip 200 is disposed on the peripheral area PA, the panel input pads 170 and corresponding input pads 220 may come into contact with one another; the panel output pads 180 and corresponding output pads 230 may come into contact with one another; and the panel alignment pads 160 and corresponding conductive alignment pads 210 may come into contact with one another.

Each of the panel alignment pads 160 may include a protrusion 162. For example, each of the panel alignment pads 160 may have a structure substantially the same as the panel input pad 170 combined with the protrusion 162 that protrudes from the panel input pad 170.

Furthermore, the panel input pads 170 may be disposed on the peripheral area PA and may be arranged between the panel alignment pads 160 along the first direction D1 (e.g., the x-axis direction). Furthermore, the panel input pads 170 may be electrically connected to second fan-out lines F02. The data driving chip 200 and the controller 400 may be electrically connected to one another through panel input pads 170. The second fan-out lines F02 may be disposed on the peripheral area PA.

The panel alignment pads 160 and the panel input pads 170 may be electrically connected to the controller 400 through the flexible circuit 410 which is partially disposed on the peripheral area PA and the controller 400. The control signal generated by the controller 400 may be applied to the data driving chip 200 through the panel alignment pads 160 and the panel input pads 170.

The panel output pads 180 may be disposed on the peripheral area PA and may be arranged along the first direction D1 (e.g., the x-axis direction). The driving signal generated by the data driving chip 200 based on the control signal may be applied to the display panel 100 through the panel output pads 180.

Furthermore, the panel output pads 180 may be disposed on the peripheral area PA and may be arranged along the first direction D1 (e.g., the x-axis direction) in the zig-zag configuration. Thus, a pitch of the first fan-out lines F01 electrically connected to the panel output pads 180 may be reduced.

The control signal generated by the controller 400 may be applied to the data driving chip 200 through the flexible substrate 410, the second fan-out lines F02, the panel input pads 170, the panel alignment pads 160, the input pads 220 and the conductive alignment pads 210.

The data driving chip 200 may generate the driving signal based on the control signal generated by the controller. The driving signal may be applied to the data line DL through the output pads 230, the panel output pads 180 and the first fan-out lines F01.

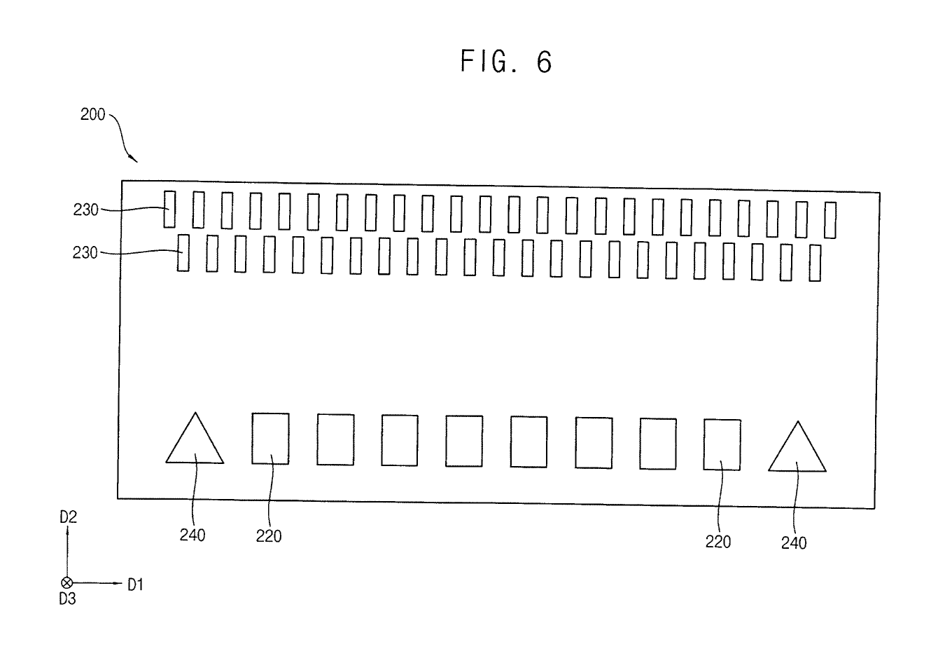

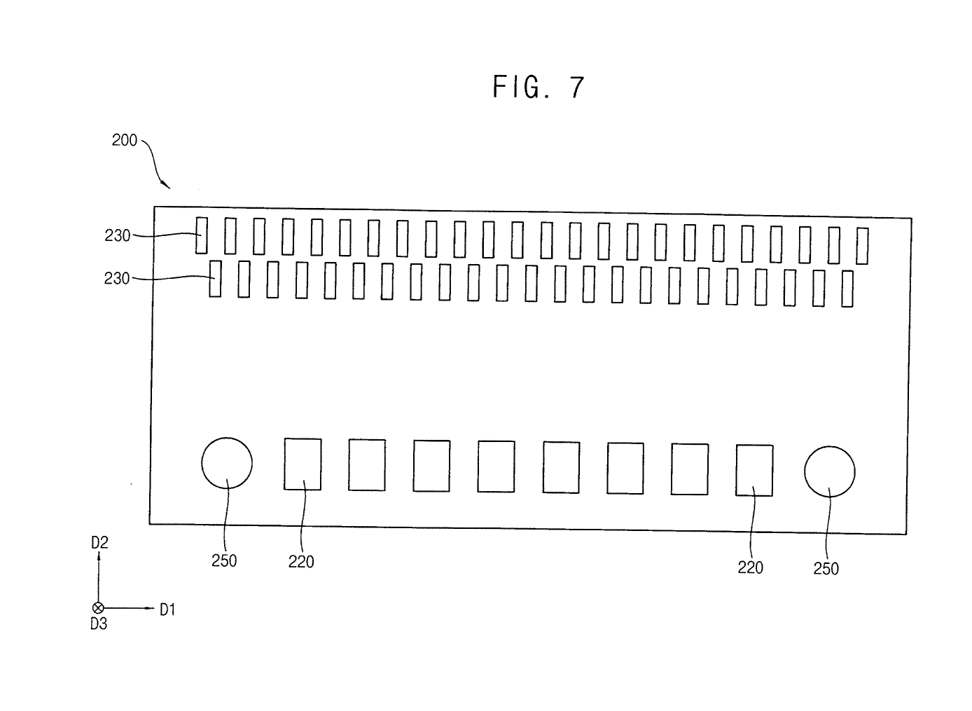

FIG. 6 is a bottom view illustrating a data driving chip according to an exemplary embodiment of the present inventive concept. FIG. 7 is a bottom view illustrating a data driving chip according to an exemplary embodiment of the present inventive concept.

As illustrated in FIGS. 6 and 7, the conductive alignment pads 240 and 250 may have a triangular shape, a circular shape or an oval shape in exemplary embodiments according to the present inventive concept. Furthermore, panel alignment pads corresponding to the conductive alignment pads 240 and 250 may have a triangular shape, a circular shape or an oval shape.

According to exemplary embodiments of the present inventive concept, the conductive alignment pads 210 are disposed on the data driving chip 200. The conductive alignment pads 210 and the input pads 220 may be configured to transfer the control signal to the data driving chip 200 Furthermore, the conductive alignment pads 210 may be used for aligning the data driving chip 200 and the display panel 100. For example, the protrusion 212 of the conductive alignment pads 220 may be aligned with protrusion 162 of the panel alignment pads 160. Thus, an additional alignment mark does not have to be disposed on the data driving chip, and a size of the data driving chip 200 and a size of the peripheral area PA of the display panel 100 may be reduced to achieve a narrow bezel. Furthermore, manufacturing costs may be reduced.

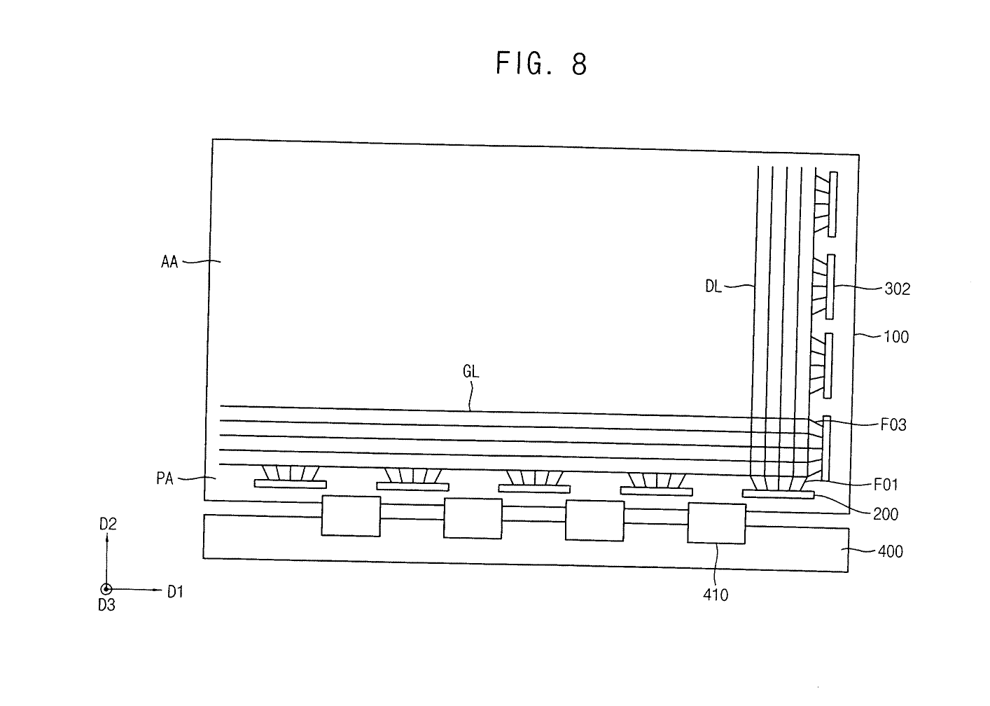

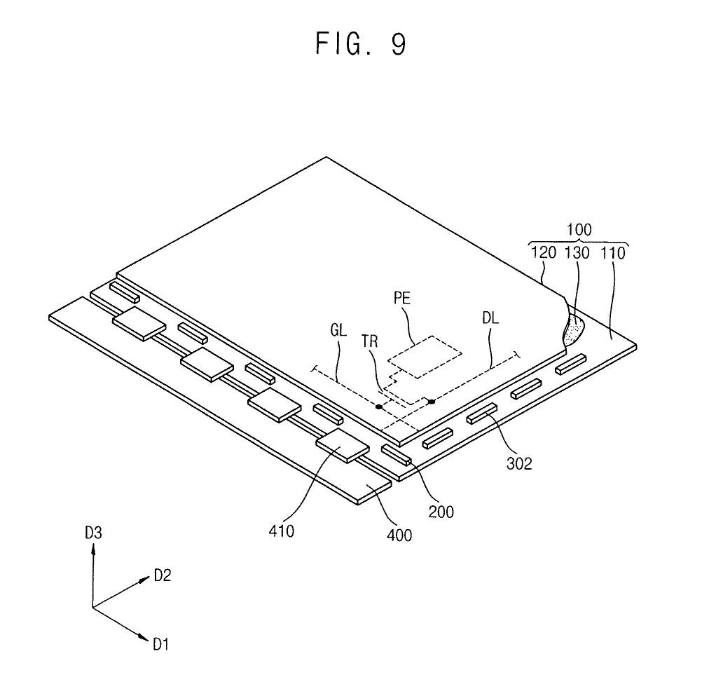

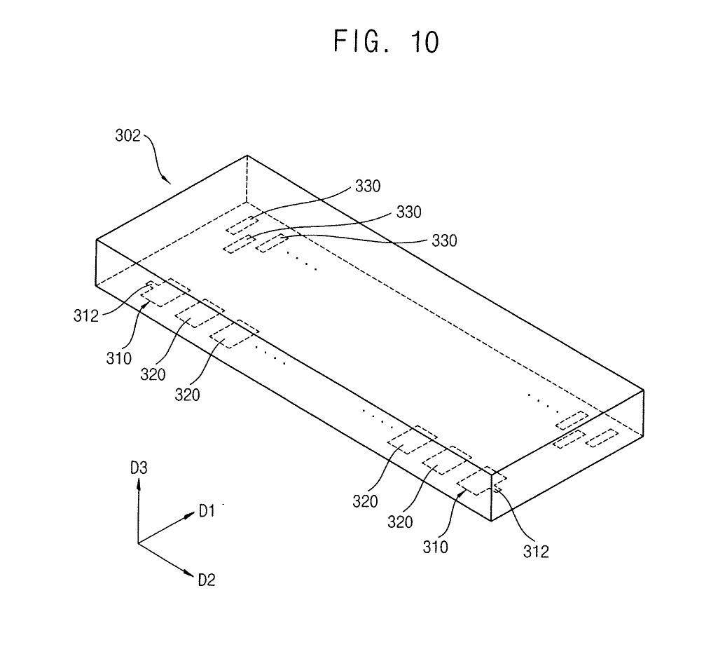

FIG. 8 is a plan view illustrating a display apparatus according to an exemplary embodiment of the present inventive concept. FIG. 9 is a perspective view illustrating the display apparatus of FIG. 8 according to an exemplary embodiment of the present inventive concept. FIG. 10 is a perspective view illustrating a gate driving chip of FIG. 8 according to an exemplary embodiment of the present inventive concept. The display apparatus illustrated in FIGS. 8 and 9 are substantially the same as the display apparatus illustrated in FIGS. 1 and 2 except FIGS. 8 and 9 may include a gate driving chip. Thus, same reference numerals may be used for same functional elements, and any repeated explanation may be omitted.

Referring to FIGS. 8 to 10, a display apparatus includes a display panel 100 and a display panel driving circuit that includes a data driving chip 200 and a gate driving chip 302.

The display panel driving circuit may include a gate driving circuit including the gate driving chip 302, and a data driving circuit may include the data driving chip 200. Further the display panel driving circuit may provide a driving signal to the display panel 100.

The gate driving chip 302 of the gate driving circuit may be disposed on a peripheral area PA, and may provide the driving signal generated by the display panel driving circuit to a gate line GL through a third fan-out line F03 electrically connected to the gate line GL.

The gate driving circuit may include a plurality of gate driving chips 302, which may be disposed on the peripheral area PA along the second direction D2 (e.g., the y-axis direction) through a chip-on-glass (COG) method.

As illustrated in FIG. 10, each of the gate driving chips 302 may include a plurality of input pads 320, a plurality of output pads 330 and a plurality of conductive alignment pads 310, which are disposed on a surface thereof.

Each of the conductive alignment pads 310 may include a protrusion 312. For example, each of the conductive alignment pads 310 may have a structure substantially similar to the input pad 320 combined with the protrusion 312 that protrudes from the input pad 320.

Furthermore, the conductive alignment pads 310 may be disposed on a first end and a second end, which may be opposite to the first end on the surface of the gate driving chip 302. For example, the surface of the gate driving chip 302 having the conductive alignment pads 310 disposed thereof may be facing the first substrate 110. The input pads 320 may be arranged along the second direction D2 (e.g., the y-axis direction) between the conductive alignment pads 310.

The output pads 330 may be disposed along the second direction D2 (e.g., the y-axis direction). Furthermore, the driving signal generated by the gate driving chip 302 may be provided to the display panel 100 through the output pads 330.

Furthermore, the output pads 330 may be arranged along the second direction D2 (e.g., the y-axis direction) the zig-zag configuration. Thus, a pitch of the third fan-out lines F03 electrically connected to the output pads 330 may be reduced.

In addition, panel input pads corresponding to and contacting the input pads 320 of the gate driving chip 302, panel output pads corresponding to and contacting the output pads 330 of the gate driving chip 302, and panel alignment pads corresponding to and contacting the conductive alignment pads 310 of the gate driving chip 302 may be disposed on the peripheral area PA of the display panel 100. For example, when the gate driving chip 302 is disposed on the peripheral area PA, the panel input pads may come into contact with the corresponding input pads 320; the panel output pads may come into contact with the corresponding output pads 330; and the panel alignment pads may come into contact with the corresponding conductive alignment pads 310.

According to an exemplary embodiment of the present inventive concept, the conductive alignment pads 310 are disposed on the gate driving chip 302. For example, the conductive alignment pads 310 may be disposed on the surface of the gate driving chip 302 facing the peripheral area PA.

Thus, an additional alignment mark does not have to be disposed on the gate driving chip 302, and a size of the gate driving chip 302 and a size of the peripheral area PA of the display panel 100 may be reduced to achieve a narrow bezel. Furthermore, manufacturing costs may be reduced.

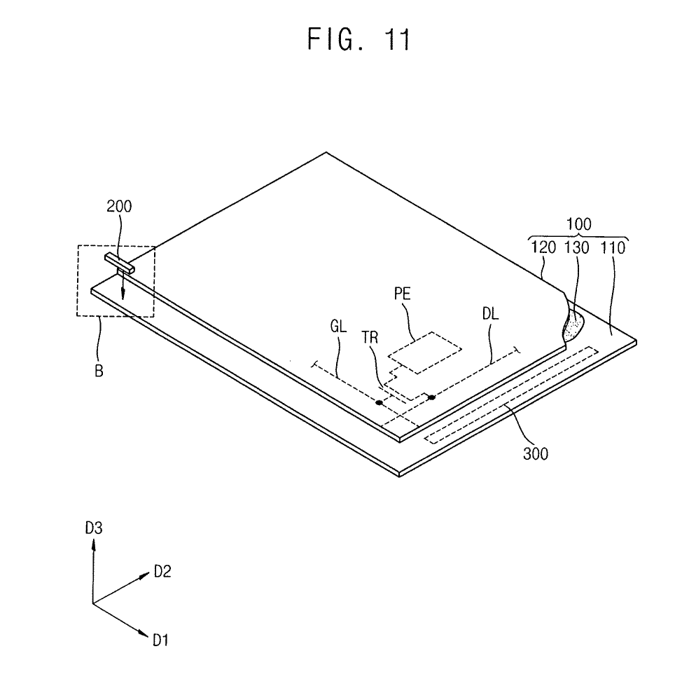

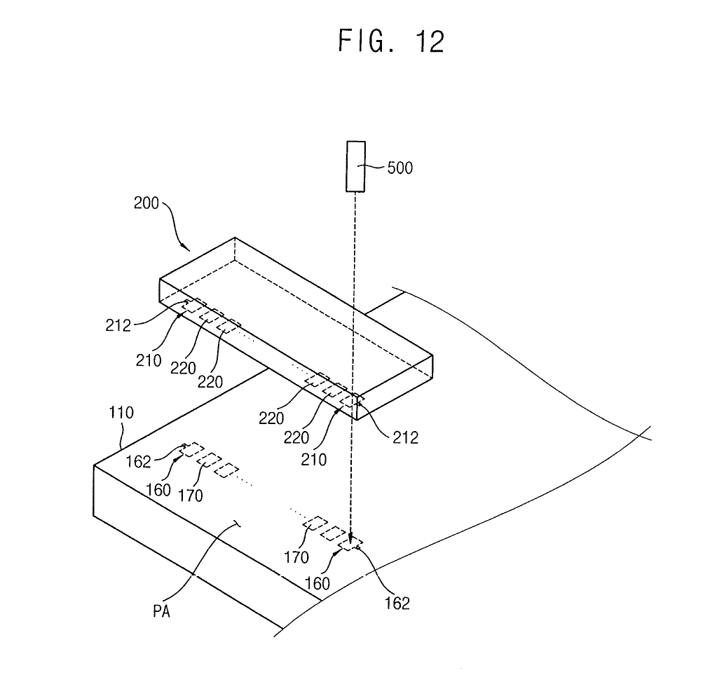

FIGS. 11, 12, 13 and 14 are perspective views and an enlarged view for illustrating a method of manufacturing a display apparatus according to an exemplary embodiment of the present inventive concept. Particularly, FIGS. 11, 13 and 14 are perspective views illustrating a method of manufacturing a display apparatus according to exemplary embodiments of the present inventive concept, and FIG. 12 is an enlarged view illustrating the region ‘B’ of FIG. 11 according to exemplary embodiments of the present inventive concept. For example, FIGS. 11 to 14 may be perspective views and an enlarged view for illustrating a method of manufacturing the display apparatus illustrated in FIG. 5.

Referring to FIGS. 11 and 12, a display panel 100 may include an active area AA (e.g., as illustrated in FIG. 1) that displays an image, and a peripheral area PA (e.g., as illustrated in FIG. 1) adjacent to the display area AA. A data driving chip 200 that includes a conductive alignment pad 210 and generates a driving signal is aligned with the peripheral area PA.

For example, a plurality of data driving chips 200 may be disposed and aligned on the peripheral area PA along a first direction D1 (e.g., the x-axis direction).

In a plan view, the data driving chip 200 may be aligned with the peripheral area PA such that the conductive alignment pad 210 of the data driving chip 200 coincides with and overlaps a corresponding panel alignment pad 160. For example, when the data driving chip 200 is disposed on the peripheral area, the conductive alignment pad 210 may be in contact with the corresponding overlapped panel alignment pad 160.

For example, an alignment apparatus 500 is disposed on the display panel 100. The alignment apparatus 500 may compare a shape of the conductive alignment pad 210 with a shape of the panel alignment pad 160 so that the shape of the conductive alignment pad 210 may coincide with and overlap the shape of the panel alignment pad 160.

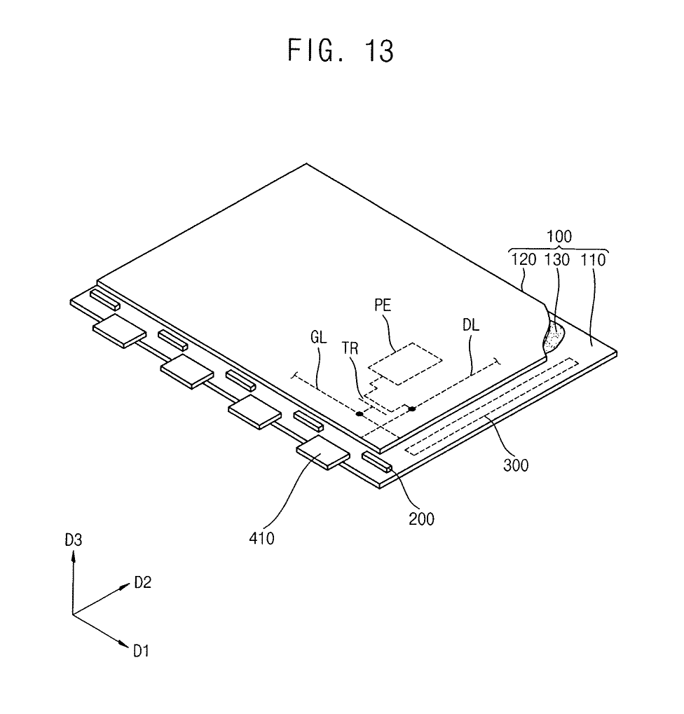

Referring to FIG. 13, the data driving chips 200 may be disposed on the peripheral area PA of the display panel 100. Furthermore, a plurality of flexible substrates 410 may be partially disposed (e.g., connected) to the peripheral area PA of the display panel 100.

For example, an anisotropic conductive film may be disposed between the flexible substrates 410 and the peripheral area PA of the display panel 100. Further, a thermal compression process may be performed to electrically connect the flexible substrates 410 to second fan-out lines F02 (e.g., as illustrated in FIG. 5) disposed on the peripheral area PA.

The flexible substrates 410 may be disposed on the peripheral area PA along the first direction D1 (e.g., the x-axis direction). In addition, each of the flexible substrates 410 may include a plurality of pads. The plurality of pads of the flexible substrates 410 may electrically contact a plurality of pads which may be disposed on the peripheral area PA and connected to the second fan-out lines F02 (e.g., as illustrated in FIG. 5).

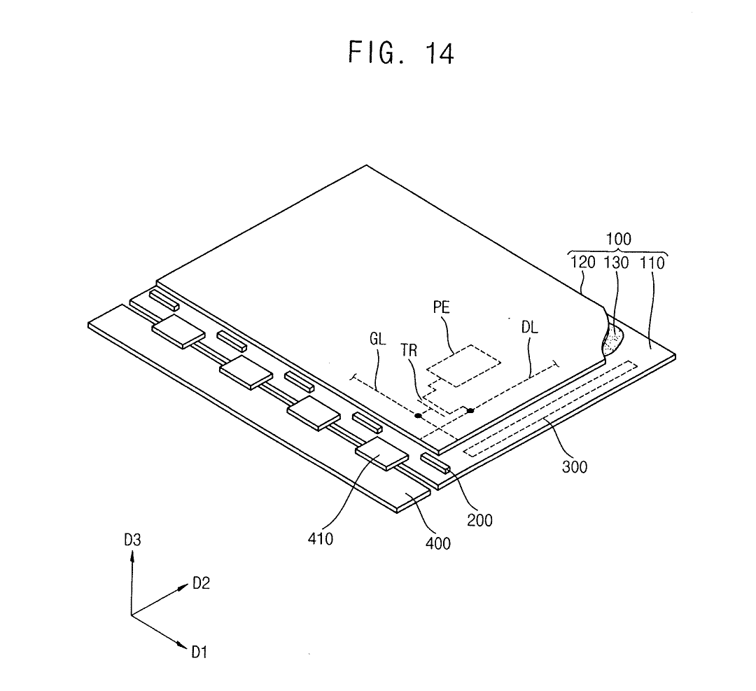

Referring to FIG. 14, a controller 400 that generates a control signal may be connected to the flexible substrates 410.

For example, an anisotropic conductive film may be disposed between the flexible substrates 410 and the controller 400. Further, a thermal compression process may be performed to electrically connect the flexible substrates 410 to the controller.

According to an exemplary embodiment of the present inventive concept, the conductive alignment pad 210 of the data driving chip 200 is aligned with the corresponding panel alignment pad 160 disposed on the peripheral area PA of the display panel so that the data driving chip 200 may be combined with the peripheral area PA without mis-alignment.

Thus, an additional alignment mark does not have to be disposed on the data driving chip 200, and a size of the data driving chip 200 and a size of the peripheral area PA of the display panel 100 may be reduced to achieve a narrow bezel. Furthermore, manufacturing costs may be reduced.

The foregoing is illustrative of exemplary embodiments of the present inventive concept and is not to be construed as limiting thereof. Although a few exemplary embodiments of the present inventive concept have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims.

What is claimed is:

1. A display apparatus comprising:
a display panel including:
a substrate including a display area and a peripheral area adjacent to the display area; and
a pixel array disposed on the display area; and
a driving chip mounted on the peripheral area and configured to provide a driving signal to the pixel array, wherein the driving chip includes a plurality of pads that are electrically connected to the display panel and disposed along a first direction, wherein the pads include an input pad and a conductive alignment pad having a shape different from a shape of the input pad.

2. The display apparatus of claim 1, wherein the conductive alignment pad includes a protrusion.

3. The display apparatus of claim 1, wherein the conductive alignment pad has a triangular shape.

4. The display apparatus of claim 1, wherein the conductive alignment pad has a circular shape or an oval shape.

5. The display apparatus of claim 1, wherein the driving chip further includes a plurality of output pads electrically connected to the pixel array and disposed along the first direction.

6. The display apparatus of claim 1, wherein the display panel further includes a panel alignment pad disposed on the peripheral area and aligned with and electrically connected to the conductive alignment pad.

7. The display apparatus of claim 6, wherein the panel alignment pad has a substantially same shape as the conductive alignment pad.

8. The display apparatus of claim 6, wherein the conductive alignment pad is disposed on a surface of the driving chip, and the panel alignment pad is disposed on a surface of the peripheral area facing the surface of the driving chip.

9. The display apparatus of claim 8, wherein the conductive alignment pad is disposed adjacent an edge of the surface of the driving chip.

10. The display apparatus of claim 1, wherein the display panel further includes a data line electrically connected to the pixel array, and the driving chip is configured to provide the driving signal to the data line.

11. The display apparatus of claim 1, wherein the display panel further includes a gate line electrically connected to the pixel array, and the driving chip is configured to provide the driving signal to the gate line.

12. The display apparatus of claim 1, wherein the display panel further includes a display layer disposed on the pixel array, wherein the display layer includes an organic light-emitting layer or a liquid crystal layer.

13. The display apparatus of claim 1, further comprising a controller electrically connected to the driving chip, and configured to generate a control signal and to output the control signal to the driving chip, wherein the driving chip is configured to generate the driving signal based on the control signal.

14. The display apparatus of claim 13, wherein the controller is connected to the display panel through a flexible substrate.

15. A method of manufacturing a display apparatus, the method comprising:
disposing a driving chip on a display panel, wherein the driving chip includes a conductive alignment pad and is configured to generate a driving signal, wherein the display panel includes a substrate including a display area and a peripheral area adjacent to the display area, a panel alignment pad disposed on the peripheral area, a pixel array disposed on the display area, and an input pad disposed on the peripheral area and is electrically connected to the pixel array;
aligning the driving chip on the peripheral area by aligning the conductive alignment pad with the panel alignment pad; and
mounting the driving chip on the peripheral area.

16. The method of claim 15, wherein the conductive alignment pad and the panel alignment pad are identical in size and shape.

17. The method of claim 16, wherein the shape of the conductive alignment pad and the panel alignment pad have a triangular, round, or oval shape.

18. The method of claim 15, further comprising connecting a controller, which is configured to generate a control signal, to the display panel.

19. A display apparatus comprising:
a display panel including:
a substrate; and
a pixel array disposed on the substrate; and
a driving chip mounted on an area adjacent to the pixel array of the substrate and configured to provide a driving signal to the pixel array, wherein the driving chip includes a string of pads arranged along a first direction on a surface of the driving chip facing the substrate, the string of pads comprising:
a plurality of conductive alignment pads, each disposed on the surface adjacent to an end of the driving chip; and
a plurality of input pads disposed between the conductive alignment pads, wherein the conductive alignment pads have a shape different from a shape of the plurality of input pads,
wherein the driving chip further includes at least two strings of output pads arranged in a zig-zag configuration along the first direction.

20. The display apparatus of claim 19, wherein the shape of each of the conductive alignment pads is rectangular and further includes a protrusion.
